(19) United States
(12) Patent Application Publication
(10) Pub. No.: US 2024/0017098 A1
(43) Pub. Date: Jan. 18, 2024

(54) BLOWER FOR RESPIRATORY PROTECTIVE EQUIPMENT

(71) Applicant: IMPERTECH INDUSTRIES LTD., Tel Aviv-Yafo (IL)

(72) Inventor: ARIEL BEN REY, JERUSALEM (IL)

(21) Appl. No.: 17/866,478

(22) Filed: Jul. 16, 2022

(51) Int. Cl. A62B 18/00; A62B 18/08

(52) U.S. Cl. CPC A62B 18/006; A62B 18/08

(57) ABSTRACT

A PAPR blower includes a frame comprised of three interconnected sections. A first flexible manifold connects between the first and second polygonal sections, and a second flexible manifold connects between the first and third polygonal sections. The second and third polygonal sections each include a respiratory filter. The first polygonal section comprises a vacuum motor and an outlet for filtered air. The vacuum motor generates a vacuum in the manifolds, thereby drawing ambient air into the respiratory filters and delivering filtered air from the respiratory filters, through the manifolds, and to the filtered air outlet. The blower may include an air delivery tube comprising a first end configured to be attached to the filtered air outlet and a second end configured to be attached to a breathing mask. The air delivery tube includes electrical wiring and a switch at the second end for controlling operation of the blower.

### FIELD OF THE INVENTION

The present Application relates to the field of respiratory protective equipment, and more specifically, but not exclusively, to a blower for a powered air-purifying respirator (PAPR) that is structured ergonomically to enable comfortable wearing in multiple positions.

### BACKGROUND OF THE INVENTION

Respiratory protective equipment enables its wearers to unrestrictedly breathe air, free of airborne noxious agents, while performing their intended tasks. Respiratory protective equipment may be worn, for example, firefighters, soldiers, or medical personnel.

An exemplary type of respiratory protective equipment is a powered air-purifying respirator (PAPR). A PAPR includes at least a blower unit, at least one filter, and a delivery tube. The blower unit draws air through the filter, which filters the air, and delivers filtered air through the delivery tube to an enclosed environment within a hood. A variety of PAPR units with these basic components are commercially available.

### SUMMARY OF THE INVENTION

PAPR units suffer from various drawbacks which make them challenging to use. First, PAPR units may be uncomfortable to wear, especially for long periods of time, due to their weight and lack of symmetry. Second, there may be a reduced ability to hear when using a PAPR unit, due to noise from the blower motor. Moreover, it may be difficult to turn the blower off and on when the blower is worn on the back, due to lack of easy access to the switch.

It is an object of the present disclosure to overcome these and other drawbacks.

The present disclosure describes a PAPR blower with a novel ergonomic design. Specifically, the battery unit, blower, and filters are arranged on a frame having flexible manifolds connecting between the blower and the filters. When the blower is strapped to the body, the flexible manifolds adapt to the shape of the body to which the blower is attached. As a result, the blower may be worn comfortably on multiple regions of the body, including the upper back, lower back, and hip.

In addition, the present disclosure describes a PAPR blower with a novel air delivery tube. The air delivery tube includes electrical wiring therein and a switch for operating the PAPR blower near an outlet of the air delivery tube. As a result, the user may operate the blower using the switch located on the tube, which is easy to access at the user's neck, rather than having to reach behind his or her back to access a switch at the blower itself.

Furthermore, the present disclosure describes a PAPR blower with a novel mechanism for sound damping. The sound damping mechanism may include a damping ring arranged around a circumference of the blower as well as a damping disc arranged opposite a face of the blower. The sound damping mechanism both reduces the sound emanating from the blower as well as reduces the vibrations generated by the blower during operation.

According to a first aspect, a PAPR blower is disclosed. The blower includes a frame comprised of three interconnected sections, wherein a first flexible manifold connects between the first and second polygonal sections, and a second flexible manifold connects between the first and third polygonal sections. The second and third polygonal sections each include a respiratory filter. The first polygonal section comprises a vacuum motor and an outlet for filtered air. When the PAPR blower is in operation, the vacuum motor generates a vacuum in the manifolds, thereby drawing ambient air into the respiratory filters and delivering filtered air from the respiratory filters, through the manifolds, and to the filtered air outlet.

In another implementation, centers of the polygonal sections are arranged in a shape of an isosceles triangle, wherein the first polygonal section is arranged at an apex of the isosceles triangle, and the second and third polygonal sections are arranged at a base of the isosceles triangle.

In another implementation, the blower further includes a plurality of adjustable straps for attaching the PAPR blower to the user's body, and plurality of slots or buckles arranged around a perimeter of the frame, each slot configured to receive therein one or more of the straps.

Optionally, when the straps are arranged within the slots or buckles and tightened around a user's body, the flexible manifolds flex, thereby adapting the PAPR blower to contours of the user's body.

Optionally, the plurality of slots or buckles comprise at least: a plurality of upper slots or buckles at an upper edge of the first polygonal section; a plurality of upper lateral slots or buckles at lateral edges of the first polygonal section; and a plurality of lower lateral slots or buckles at lateral edges of the second and third polygonal sections.

Optionally, the straps are configurable in different orientations relative to the slots or buckles, for wearing of the PAPR blower on the user's back, waist, and thigh. Optionally, when the PAPR blower is worn on the user's back, a first strap is threaded through into the lower lateral slots or buckles and encircles the user's back, and a second strap is threaded through into the upper slots or buckles and reaches from the user's back to the user's chest. Optionally, when the PAPR blower is worn on the user's waist, a first strap is threaded into through the lower lateral slots or buckles and encircles the user's lower waist, and a second strap is threaded into the upper lateral slots or buckles and encircles the user's upper waist. Optionally, when the PAPR blower is worn on the user's thigh, a first strap is threaded through into the lower lateral slots or buckles and encircles the user's lower thigh, and a second strap is threaded into the upper lateral slots or buckles and encircles the user's waist.

In another implementation, the blower includes a removable battery receptacle configured to be attached to the vacuum motor at the first polygonal section. Optionally, the battery receptacle is removable from and replaceable onto the vacuum motor with a screwing motion, wherein the screwing motion effects both a physical and electrical connection. Optionally, the battery receptacle is attachable to an external face of the first polygonal section relative to the user's body. When the battery receptacle is attached to the first polygonal section, a mass of the PAPR blower is evenly distributed among the first, second, and third polygonal sections.

In another implementation, the blower includes an air delivery tube. The air delivery tube includes a first end configured to be attached to the filtered air outlet and a second end configured to be attached to a breathing mask. The air delivery tube comprises electrical wiring and a switch at or adjacent to the second end for controlling operation of the PAPR blower.

Optionally, the blower further includes electrical contacts and a mechanical connector configured on the first end, wherein the electrical contacts are arranged such that connection of the mechanical connector to the outlet for filtered air automatically connects the electrical contacts to corresponding electrical contacts at the outlet for filtered air.

Optionally, the electrical wiring is folded or coiled within the air delivery tube such that an expanded length of the electrical wiring is up to 40 50% greater than a length of the air delivery tube when the air delivery tube is not expanded.

In another implementation, the blower further includes a damping ring for damping noise and vibration, said damping ring configured between the vacuum motor and an external casing of the PAPR blower. Optionally, the damping ring includes a plurality of through holes and a plurality of ridges. Optionally, the damping ring is substantially cylindrical and is arranged circumferentially around the vacuum motor.

Optionally, the blower further includes at least one damping cylinder arranged opposite a face of the vacuum motor. Optionally, the damping cylinder includes a plurality of through holes, wherein the through holes have a diameter adapted to damp vibrations of a frequency generated by the vacuum motor based on Helmholtz resonance.

### BRIEF DESCRIPTION OF THE DRAWINGS

FIG. 1 is a front view of an assembled PAPR blower, according to embodiments of the present disclosure;

FIG. 2 is a partially exploded perspective view of the PAPR blower of FIG. 1, illustrating certain connection points between different components thereof, according to embodiments of the present disclosure;

FIG. 3 is a rear perspective view of the PAPR blower of FIG. 1, according to embodiments of the present disclosure;

FIGS. 4A and 4B are side views of the PAPR blower in flexed and relaxed positions, according to embodiments of the present disclosure;

FIGS. 5A-5C illustrate three positions for wearing the PAPR blower of FIG. 1, according to embodiments of the present disclosure;

FIG. 6 illustrates an air delivery tube for use with the PAPR blower of FIG. 1, according to embodiments of the present disclosure;

FIG. 7 illustrates first end of the air delivery tube of FIG. 6, according to embodiments of the present disclosure;

FIG. 8 illustrates a second end of the air delivery tube of FIG. 6, according to embodiments of the present disclosure;

FIG. 9 is an exploded view of the blower showing internal components thereof, according to embodiments of the present disclosure;

FIGS. 10A and 106 are front and rear perspective views of a damping ring, according to embodiments of the present disclosure;

FIG. 10C is a perspective view of a damping disc, according to embodiments of the present disclosure; and

FIG. 10D is a perspective view illustrating the damping ring and damping disc arranged over the blower, according to embodiments of the present disclosure.

### DETAILED DESCRIPTION OF THE INVENTION

The present Application relates to the field of respiratory protective equipment, and more specifically, but not exclusively, to a blower for a powered air-purifying respirator (PAPR) that is structured ergonomically to enable comfortable wearing in multiple positions.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

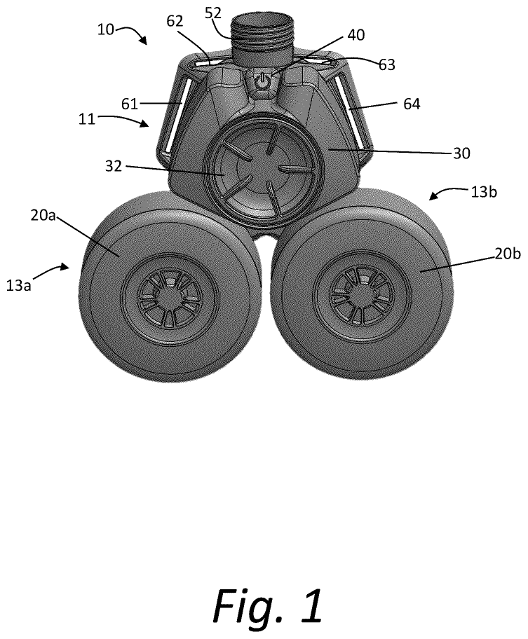

Referring to FIGS. 1-4B, PAPR blower 10 is comprised of frame 12 which includes polygonal sections 11, 13a, and 13b. The frame 12 may be constructed of any suitable material, e.g., polycarbonate.

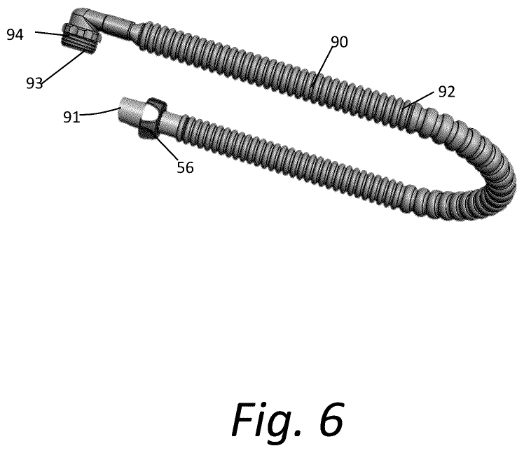

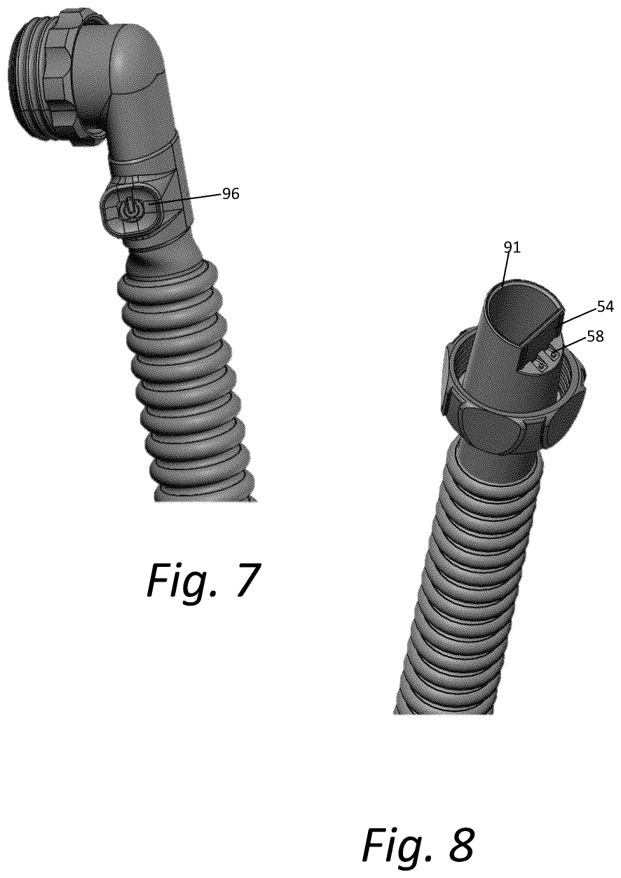

Polygonal section 11 houses vacuum motor 50. Vacuum motor 50 is powered by batteries in removable battery receptacle 30, and turned on and off with switch 40. Vacuum motor 50 has an outlet 52 for delivery of filtered air to an air delivery tube 90 (shown in FIGS. 6, 7, and 8). Polygonal sections 13a, 13b house respiratory filters 20a, 20b. The respiratory filters 20a, 20b may be, for example, CBRN filters.

Polygonal sections 11, 13a, and 13b are joined by flexible manifolds 16a, 16b. Manifolds 16a, 16b are hollow and are configured to deliver filtered air therethrough, from the respiratory filters 20a, 20b, to the vacuum motor 50. When the PAPR blower 10 is in operation, the vacuum motor 50 generates a vacuum in the manifolds, thereby drawing ambient air into the respiratory filters and delivering filtered air from the respiratory filters, through the manifolds, and to the filtered air outlet. The blower 10 is capable of delivering approximately 120 liters of filtered air per minute.

In the illustrated embodiments, the polygonal sections 11, 13a, 13b are arranged substantially in the shape of an isosceles triangle. First polygonal section 11 is arranged at the apex of the triangle, and second and third polygonal sections 13a, 13b are arranged at the base of the isosceles triangle. Advantageously, the symmetric configuration of the polygonal sections enables the blower 10 to be mounted to the body in multiple configurations, as will be discussed further herein.

Referring to FIG. 2, battery receptacle 30 is attachable to the first polygonal section 11 through operation of a screwing motion. Specifically, handhold 32 may be used to screw the battery receptacle onto threads 34. The battery receptacle 30 further includes electrical contacts 42 which are adapted to form an electrical connection with corresponding electrical contacts 44 for the vacuum motor 50. The screwing motion effects both a physical and electrical connection, such that, when the battery receptacle is fully threaded onto threads 34, the electrical connection is completed without requiring any additional connection activity.

The batteries within battery receptacle 30 may be one or more single-use batteries. For example, battery receptacle 30 may contain eight AA batteries, which may support filtering operation for approximately 4 to 8 hours in a CBRN environment. Alternatively, the batteries may be one or more rechargeable batteries. For example, the batteries may be four 5.8V lithium batteries, which may support filtering operation for approximately 7-9 hours. Advantageously, the removable battery receptacle 30 allows external charging and the removal of a battery receptacle with an empty battery and its replacement with a full battery. In addition, the position of the battery receptacle 30 at an external face of the blower 10 (i.e., not adjacent to the user's body) allows for the battery to be replaced when the blower 10 is still adhered to the body, and allows the new batteries to be easily and safely screwed on.

When the battery receptacle 30 is attached to the first polygonal section 11, a mass of the PAPR blower is evenly distributed among the first, second, and third polygonal sections. That is, a center of mass of the PAPR blower is at the centroid of the isosceles triangle defined by the vacuum motor 50, respiratory filter 20a, and respiratory filter 20b. The resulting balancing of the mass of the PAPR blower 10, in combination with the flexing of the manifolds 16 enables the blower to be situated comfortably at multiple locations on the body, without distancing any portion of the blower 10 from the body, thereby reducing shaking of the blower 10 and strain on the body.

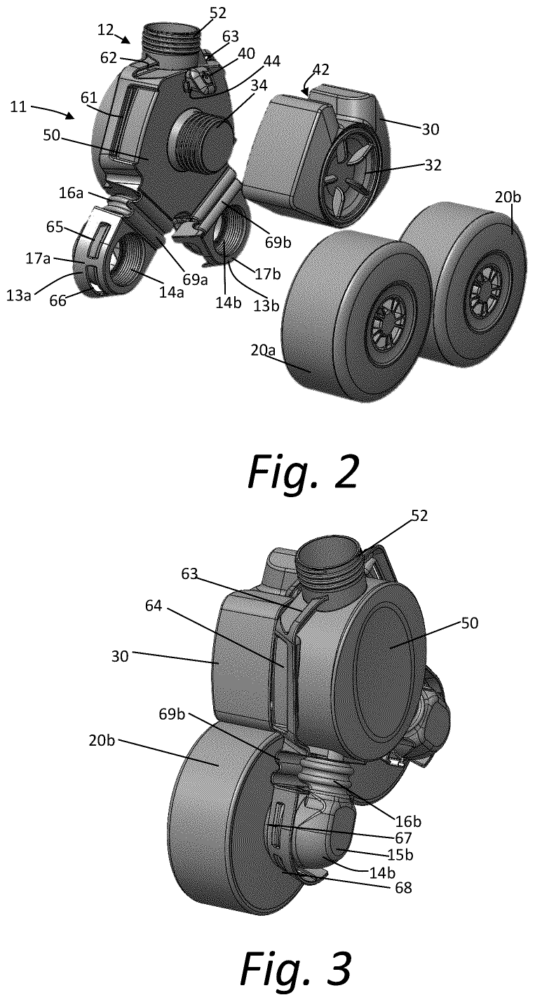

FIGS. 2 and 3 show specifically the components that make up a flow path of filtered air between the respiratory filters 20a, 20b and the vacuum motor 50. Each polygonal section 13a, 13b includes a receptacle 14a, 14b with a back 15a, 15b, into which CBRN filter 20a, 20b is inserted. Specifically, each receptacle 14a, 14b has a threaded ring 18a, 18b therein, for screwing therein a respective respiratory filter 20a, 20b. The threaded rings 18 may be compatible with a standard NATO RD40 connection. The connection between the receptacles 14a, 14b and the respiratory filters 20a, 20b may alternatively be accomplished through any other mechanism known to those of skill in the art. The cavity formed by receptacles 14a, 14b and backs 15a, 15b, is fluidically connected to the corresponding manifold 16a, 16b. Optionally, receptacle 14a, 14b and back 15a, 15b may be formed integral with manifolds 16a, 16b, for example, through molding or additive manufacturing.

As seen in FIGS. 1-4B, the blower 10 includes multiple slots for passing straps therethrough. The slots are mounted at various locations around the perimeter of each of the polygonal sections 11, 13a, 13b. Specifically: slots 62 and 63 (collectively referred to herein as upper slots) are located at an upper edge of first polygonal section 11; slots 61 and 64 (collectively referred to herein as upper lateral slots) are at the lateral edges of section 11. Slots 65 and 66 are at the perimeter of receptacle 14a, and slots 67 and 68, are at the perimeter of receptacle 14b. Slots 65-68 are collectively referred to herein as lower lateral slots.

In the illustrated embodiments, the slots are merely locations for the straps to pass through, and the straps are fastened through a conventional fastening mechanism along the straps themselves. In alternative configurations, the slots are formed as the latch of a buckle, with the straps including the tongue of the buckle.

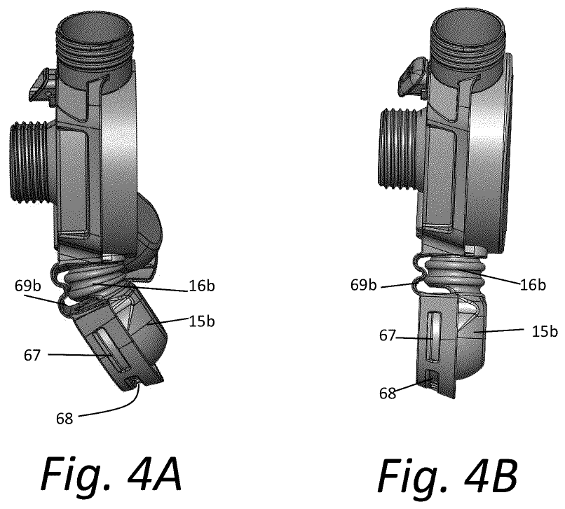

When straps are inserted into one or more slots or buckles, and tightened against the body of the user, the manifolds 16a, 16b may flex. This flexing of the manifolds 16a, 16b is counterbalanced by a spring force of springs 69a,69b, which bias the manifolds 16a, 16b from the flexed position of FIG. 4A to the straight position of FIG. 4B. The flexing of the manifolds 16a, 16b adapts the PAPR blower 10 to contours of the user's body. Advantageously, the flexible 3D design of the blower 10 allows the blower 10 to adjust to every curve and body structure of each user. The flexible design also provides shock and impact absorption.

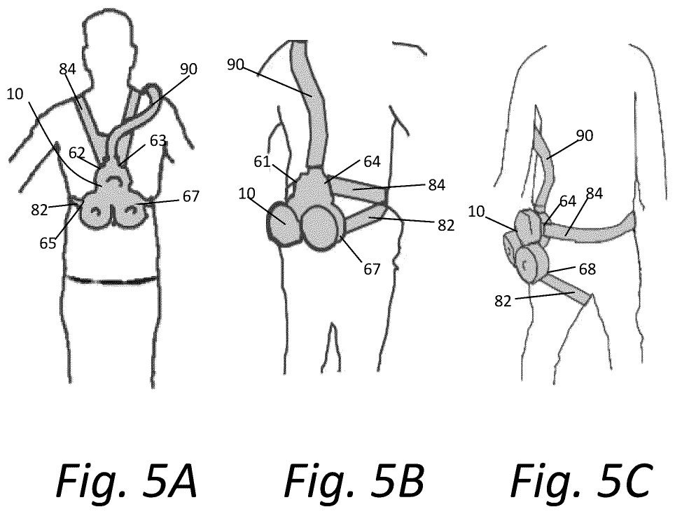

FIGS. 5A-5C illustrate how straps 82, 84 may be placed into different slots in order to enable different harnessing positions for blower 10. As discussed above, although the description below is in reference to threading straps into slots, the same principles apply for threading straps into buckles (i.e., latching the end of the strap into the buckle).

In the view of FIG. 5A, the blower 10 is worn on the upper back. A first strap 82 is threaded into lower lateral slots 65 and 67, and encircles the user's back. A second strap is threaded into upper slots 62 and 63, and reaches from the user's back to the user's chest. Straps 82, 84 meet in the region of the user's chest. Air delivery tube 90 extends from the blower 10 to the region of the user's mouth, over the user's shoulder.

In the view of FIG. 5B, the blower 10 is worn on the waist. First strap 82 is threaded into lower lateral slots 65 (not shown) and 67, and encircles the user's lower waist. Second strap 84 is threaded into upper lateral slots 61 and 64, and encircles the user's upper waist. Air delivery tube 90 extends from the blower 10 to the region of the user's mouth, over the user's shoulder.

In the view of FIG. 5C, the blower 10 is worn on the thigh. First strap 82 is threaded into lower lateral slots 66 (not shown) and 68, and encircles the user's lower thigh. Second strap 84 is threaded into slots 61 and 64 and encircles the user's waist. Air delivery tube 90 extends from the blower 10 to the region of the user's mouth, in this case under the user's arm.

The ability to wear the blower 10 in three different positions represents a significant advance over known blowers, which are typically able to be worn only in one or two positions. Specifically, the user is able to adjust the location of the blower in response to different needs, such as a desire to situate the weight in a different location, or a desire to utilize different locations on the body for harnessing of other devices. Due to the flexing of the manifolds 16a, 16b, and springs 69a, 69b, as well as the symmetric orientation of the blower 10 the blower 10 adapts equally well to the different locations on which it is situated in FIGS. 5A-5C.

Although the blower is illustrated as being in three specific locations in FIGS. it is evident that the blower may likewise be situated in different locations on the body, as desired. For example, the blower may alternatively be situated on the user's chest, or on the side of the user's waist. In each case, the symmetry and flexibility of the blower 10 enables the blower to be worn in comfort, as discussed.

FIGS. 6-8 illustrate aspects of the air delivery tube 90 in greater detail. Air delivery tube 90 is made of a flexible casing 92. The flexible casing 92 may be made of any suitable flexible material, such as rubber. The casing 92 may be comprised of an inner layer and an outer layer, with one or more electric wires contained therebetween.

Air delivery tube 90 includes a proximal end 91, with a mechanical connector 56 for a screw-based connection with the filtered air outlet 52 of the blower 10, and a distal end 93 having a screw-based connector 94 for connection with a CBRN gas mask (not shown). The airflow connections between the tube 90 and the filtered air outlet 52 and the gas mask may be, for example, standard RD40 connections.

The gas mask may be any gas mask known to those of skill in the art. In one particularly advantageous example, the gas mask is equipped with an integrated interface platform for respiratory protective equipment. The integrated interface platform may include an air inlet interface, to which the distal end 93 connects, and may further include interfaces for air outlets, drinking, speech, and communication. An exemplary integrated interface platform is disclosed in Israeli patent application 289562, filed Jan. 2, 2022, entitled “A Platform For Respiratory Protective Equipment,” the contents of which are incorporated by reference as if fully set forth herein.

At the distal end 93, on/off switch 96 may be used to control operation of the blower 10. The external portion of the switch 96 is formed integrally with the outer layer of the air delivery tube 90, as a result, the switch 96 and the tube 90 comprise a single unit. The switch 96 may alternatively be located on or at the connector 94; when the connector 94 is attached to the tube 90, the switch 96 and the tube 90 are united into a single device. Advantageously, switch 96 allows the user to control operation of the blower from a region around the user's neck, without contorting to access switch 40, which would often be located behind the user's back.

At the proximal end 91, air delivery tube 90 also forms an electrical connection with the vacuum motor 50. End 91 includes a female connector end 54, which includes recessed electrical contacts 58. The electrical contacts 58 are connected to the wires within air delivery tube 90. The outlet 52 of the vacuum motor 50 has a corresponding male connector end (not shown) with protruding electrical contacts (not shown). The mating of the connector ends is necessary in order to effect an airtight connection between outlet 52 and end 91. Outlet 52 and end 91 may further include guides for assisting in the alignment of the male and female electrical connectors, and for permitting the mechanical connector 56 to close only when the connectors are properly aligned. When the electrical connectors are properly aligned, end 91 is properly lined up with outlet 52, and mechanical connector 56 is properly screwed onto the threads of outlet 52, an electrical connection is formed with the vacuum motor 50.

Air delivery tube 90 is expandable and retractable. This expansion and retraction may be accomplished through stretching of the rubber or similar materials from which the air delivery tube 90 is made. Other mechanisms for expansion may similarly be used, as may be recognized by those of skill in the art. The elongation of the air delivery tube is useful in order to enable use of the air delivery tube 90 by users having different heights. The elongation is also useful for accommodating different mounting locations of the blower on the body. For example, a user requires a longer air delivery tube 90 when carrying the blower 10 on the thigh as compared to when carrying the blower 10 on the back. The ability to retract portions of the air delivery tube 90 ensures that the tube 90 does not flop around, which would potentially interfere with other activities being performed by the user.

The electrical wire within the air delivery tube 90 may be elongated or shortened by up to 50%. This elongation ensures that the wire will not be damaged when the tube 90 is expanded. This degree of expansion may be greater than the degree of expansion of the tube 90 itself. The expansion may be accomplished through one or more of the following techniques: 1) leaving extra length of wire in the interstitial space between the inner and outer layers; implementing at least a portion of the wire as a spiral wire that is inherently able to be stretched; or use of a spring mechanism that keeps the wire taut but permits expansion of the wire when desired.

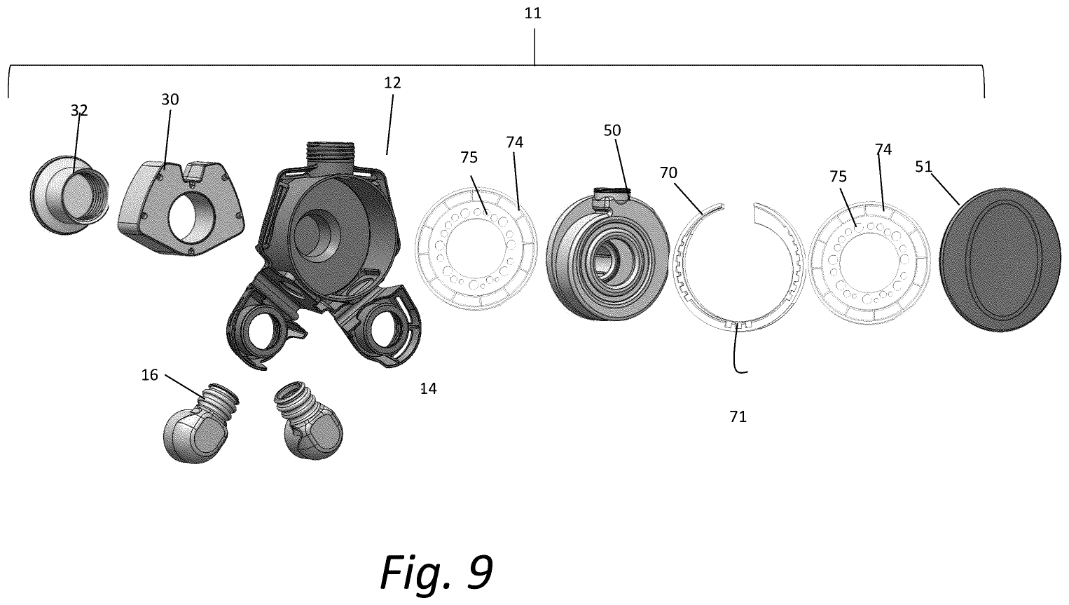

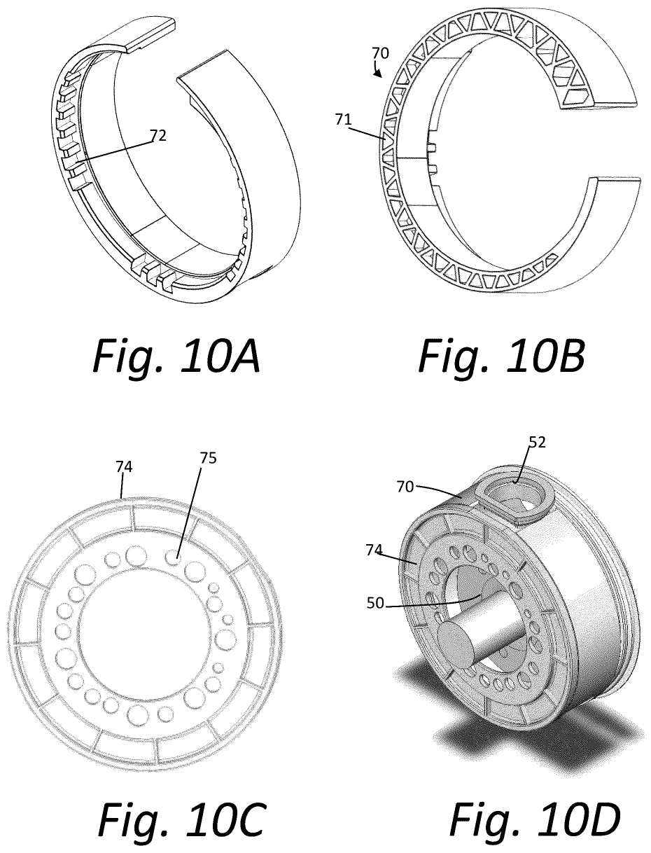

FIGS. 9 and 10A-10D depict various internal components of the vacuum motor and in particular a system that is used for damping noise and vibrations generated by the vacuum motor 50. FIG. 9 illustrates an exploded view of the components of the first polygonal section 11. From left to right, first polygonal section 11 includes battery connector 32; battery receptacle 30; frame 12 and flexible manifolds 16; first damping cylinder 74; vacuum motor damping ring 70; second damping cylinder 74 and rear cover 51 of the vacuum motor 50.

FIG. 10A and FIG. 10B display front and rear perspective views of the damping ring 70. Damping ring 70 is made of a flexible polymer such as polyurethane, silicone, rubber, or another suitable shock-absorbing material. Ring 70 is sized to encircle the vacuum motor and performs at least the following functions. First, ring 70 fixes the location of the vacuum motor 50 between the frame 12 and the rear cover 51, and thus prevents jiggling of the vacuum motor within the frame 12. In addition, the through holes 71 and ridges 72 of the ring 70 absorb vibrations generated by the vacuum motor 50. This, in turn, prevents transmission of sound waves from within the frame to outside the frame, and also prevents generation of echoes within the internal structure of the frame 12. Simultaneously, the through holes 71 and ridges 72 provide passageways for the circulation of air within the internal space of the blower 10.

In particular, the damping ring 70 reduces transmission of sound from the vacuum motor 50 to the exterior of the blower 10 based on general principles of sound attenuation, such as those that are used to measure Apparent Sound Transmission Class (ASTC). The principles of sound attenuation that are used to measure ASTC are explicated, inter alia, in ASTM Standard E336. The damping ring achieves this reduction in sound transmission, at least in part, through the asymmetry of the lattice structure of the through holes 71, which causes sound to be trapped within the damping ring 70. Preferably, a decibel level of the sound exiting the blower 10 is no greater than 50 dB.

FIG. 10C displays a perspective view of the damping cylinder 74. Damping cylinder 74 may be made of the same materials as damping ring 70. Damping cylinder 74 includes holes 75. Similar to through holes 71, holes 75 absorb shock and vibrations, and separate the vacuum motor 50 from the exterior of frame 12, in order to prevent transmission of vibrations to the exterior and corresponding creation of sound waves. However, unlike damping ring 70, which operates based on general sound damping principles, holes 75 have specific diameters which are used to dampen sound waves of specific frequencies that are generated by operation of the blower 10. These diameters are calculated based on the resonance formula of a Helmholtz resonator. Specifically, holes 75 have the effect of suppressing the particular frequencies generated by the vacuum motor 50, for example, during spinning of the vacuum motor to produce a vacuum. The efficacy of damping cylinder 74 with respect to the targeted frequencies may be measured with the Noise Reduction Coefficient (NRC).

The damping cylinders 74 also help fix the vacuum motor in place during assembly of the blower 10. Together, the damping ring 70 and two damping cylinders 74 form a complete sound isolation structure, which encompasses the vacuum motor 50 entirely, except for the exit location of outlet 52.

Optionally, damping cylinders 74 may include a spongy layer (not shown), for further absorptions of vibrations. In such embodiments, in order to enable operation of the Helmholtz resonance, the holes 75 are always oriented facing the vacuum motor 50, while the spongy layer is located on an outer face of the damping cylinder, toward an exterior wall of the blower 10.

FIG. 10D illustrates the damping ring 70 and damping cylinder 74 arranged around vacuum motor 50. Outlet 52 is exposed for delivery of the filtered air to air delivery tube 90.

What is claimed is:

1. A PAPR blower, comprising:
a frame comprised of three interconnected sections, wherein a first flexible manifold connects between first and second polygonal sections, and a second flexible manifold connects between the first and third polygonal sections;
wherein the second and third polygonal sections each include a respiratory filter;
wherein the first polygonal section comprises a vacuum motor and an outlet for filtered air;
wherein, when the PAPR blower is in operation, the vacuum motor generates a vacuum in the manifolds, thereby drawing ambient air into the respiratory filters and delivering filtered air from the respiratory filters, through the manifolds, and to the filtered air outlet.

2. The PAPR blower of claim 1, wherein centers of the polygonal sections are arranged in a shape of an isosceles triangle, wherein the first polygonal section is arranged at an apex of the isosceles triangle, and the second and third polygonal sections are arranged at a base of the isosceles triangle.

3. The PAPR blower of claim 1, further comprising a plurality of adjustable straps for attaching the PAPR blower to a user's body, and a plurality of slots or buckles arranged around a perimeter of the frame, each slot or buckle configured to receive therein one or more of the straps.

4. The PAPR blower of claim 3, wherein when the straps are arranged within the slots or buckles and tightened around a user's body, the flexible manifolds flex, thereby adapting the PAPR blower to contours of the user's body.

5. The PAPR blower of claim 3, wherein the plurality of slots or buckles comprise at least: a plurality of upper slots or buckles at an upper edge of the first polygonal section; a plurality of upper lateral slots or buckles at lateral edges of the first polygonal section; and a plurality of lower lateral slots or buckles at lateral edges of the second and third polygonal sections.

6. The PAPR blower of claim 5, wherein the straps are configurable in different orientations relative to the slots or buckles, for wearing of the PAPR blower on the user's back, waist, and thigh.

7. The PAPR blower of claim 6, wherein, when the PAPR blower is worn on the user's back, a first strap is threaded into the lower lateral slots or buckles and encircles the user's back, and a second strap is threaded into the upper slots or buckles and reaches from the user's back to the user's chest.

8. The PAPR blower of claim 6, wherein, when the PAPR blower is worn on the user's waist, a first strap is threaded into the lower lateral slots or buckles and encircles the user's lower waist, and a second strap is threaded into the upper lateral slots or buckles and encircles the user's upper waist.

9. The PAPR blower of claim 6, wherein, when the PAPR blower is worn on the user's thigh, a first strap is threaded into the lower lateral slots or buckles and encircles the user's lower thigh, and a second strap is threaded into the upper lateral slots or buckles and encircles the user's waist.

10. The PAPR blower of claim 1, further comprising a removable battery receptacle configured to be attached to the vacuum motor at the first polygonal section.

11. The PAPR blower of claim 10, wherein the battery receptacle is removable from and replaceable onto the vacuum motor with a screwing motion, wherein the screwing motion effects both a physical and electrical connection.

12. The PAPR blower of claim 10, wherein the battery receptacle is attachable to an external face of the first polygonal section relative to the user's body.

13. The PAPR blower of claim 10, wherein, when the battery receptacle is attached to the first polygonal section, a mass of the PAPR blower is evenly distributed among the first, second, and third polygonal sections.

14. The PAPR blower of claim 1, further comprising an air delivery tube, said air delivery tube comprising a first end configured to be attached to the filtered air outlet and a second end configured to be attached to a breathing mask, wherein the air delivery tube comprises electrical wiring and a switch at or adjacent to the second end for controlling operation of the PAPR blower.

15. The PAPR blower of claim 14, further comprising electrical contacts and a mechanical connector configured on the first end, wherein the electrical contacts are arranged such that connection of the mechanical connector to the outlet for filtered air automatically connects the electrical contacts to corresponding electrical contacts at the outlet for filtered air.

16. The PAPR blower of claim 14, wherein the electrical wiring is folded or coiled within the air delivery tube such that an expanded length of the electrical wiring is up to 50% greater than a length of the air delivery tube when the air delivery tube is not expanded.

17. The PAPR blower of claim 1, further comprising a damping ring for damping noise and vibration, said damping ring configured between the vacuum motor and an external casing of the PAPR blower.

18. The PAPR blower of claim 17, wherein the damping ring includes a plurality of through holes and a plurality of ridges.

19. The PAPR blower of claim 17, wherein the damping ring is substantially cylindrical and is arranged circumferentially around the vacuum motor.

20. The PAPR blower of claim 17, further comprising at least one damping cylinder arranged opposite a face of the vacuum motor.

21. The PAPR blower of claim 20, wherein the damping cylinder includes a plurality of through holes, wherein the through holes have a diameter adapted to damp vibrations of a frequency generated by the vacuum motor based on Helmholtz resonance.
